(19) United States
(12) Patent Application Publication
(10) Pub. No.: US 2018/0297582 A1
(43) Pub. Date: Oct. 18, 2018

(54) METHOD AND DEVICE FOR OPERATING A DRIVE DEVICE, AND DRIVE DEVICE

(71) Applicant: Robert Bosch GmbH, Stuttgart (DE)

(72) Inventors: Klaus Theiss, Altheim (DE); Bernhard Matrohs, Ebersbach (DE); Detlev Bareuther, Wernau (DE)

(73) Assignee: Robert Bosch GmbH, Stuttgart (DE)

(21) Appl. No.: 15/766,442

(22) PCT Filed: Sep. 1, 2016
(86) PCT No.: PCT/EP2016/070577

§ 371 Date: Apr. 6, 2018

(30) Foreign Application Priority Data
Oct. 7, 2015 (DE) 10 2015 219 337.3

(51) Int. Cl. B60W 20/15; F02B 37/00; F02B 37/013; F02B 37/16; F02B 37/18; F02D 41/00; B60W 10/06; B60W 10/08

(52) U.S. Cl. CPC B60W 20/15; B60K 6/48; F02B 37/013; F02B 37/16; F02B 37/18; F02D 41/0007; B60W 10/06; B60W 10/08; B60W 2540/10; B60W 2510/0633; B60W 2710/0638; B60W 2710/0666; B60W 2710/083; B60Y 2200/92; F02B 37/004

(57) ABSTRACT

The invention relates to a method for operating a drive device (1) of a motor vehicle, comprising an internal combustion engine (2) having a first exhaust gas turbocharger (5) and a second exhaust gas turbocharger (6), and comprising at least one electric machine (3), wherein the exhaust gas turbochargers (5, 6) are connected in series, wherein at least the second exhaust gas turbocharger (6) has means for varying the output thereof, and wherein the output at least of the second exhaust gas turbocharger (6) is varied in accordance with a required target torque of the drive device (1). According to the invention, the electric machine (3) is controlled in accordance with the time of the variation, in order to compensate for a deviation of an actual torque of the drive device (1) from the target torque.

### BACKGROUND OF THE INVENTION

The invention relates to a method for operating a drive device of a motor vehicle, which drive device has an internal combustion engine with a first exhaust gas turbocharger and a second exhaust gas turbocharger, and at least one electric machine, the exhaust gas turbochargers being connected in series, at least the second exhaust gas turbocharger having means for varying its performance, the performance of at least the second exhaust gas turbocharger being varied in a manner which is dependent on a requested setpoint torque of the drive device.

Furthermore, the invention relates to a device for operating the above-described drive device, and to a corresponding drive device.

Methods, devices and drive devices of the type mentioned at the outset are known from the prior art. In order to increase the performance of an internal combustion engine, it is known to assign the internal combustion engine an exhaust gas turbocharger which is driven by the exhaust gas of the internal combustion engine and feeds compressed fresh air to the internal combustion engine for combustion. In order to further increase the performance, and in order to obtain increased variability, it is known, moreover, to assign the internal combustion engine two exhaust gas turbochargers which are connected in series, the internal combustion engine and the exhaust gas turbochargers being actuated in a manner which is dependent on a requested setpoint torque of the drive device, in order firstly to implement the setpoint torque or desired torque, and in order secondly to obtain optimum operating points of the components of the drive device in relation to consumption and emissions. To this end, at least one of the exhaust gas turbochargers, usually the two exhaust gas turbochargers, is/are in each case assigned means for influencing the performance of the respective exhaust gas turbocharger. The means are, for example, electropneumatic actuators, actuable wastegate valves and/or variable flow geometries. Unavoidable boost pressure drops occur in the case of a variation of the performance of at least one of the exhaust gas turbochargers, in particular in the case of a switchover from two stage operation to one stage operation. During acceleration, moreover, the boost pressure is also built up in a delayed manner, since the enthalpy which is required for the boost pressure is not (yet) available on the turbine side. A cause for a deviation of this type of the boost pressure from a desired setpoint boost pressure is that the exhaust gas mass flow cannot be adjusted rapidly enough to the required control variable, that is to say to the setpoint boost pressure.

As a result, a desired setpoint torque can be provided by way of the drive device only in a delayed manner. In the case of a sudden increase in the setpoint torque and in the case of variations of the performance of one or both exhaust gas turbochargers, a delay of this type leads to a loss of comfort, in particular a lack of agility, during driving operation.

Laid open specification DE 10 2007 012 303 A1 has already disclosed a method for operating a hybrid drive which has an internal combustion engine and an electric machine as drive units, in which method the electric machine is actuated to compensate for a deviation of an actual torque from a setpoint torque.

### SUMMARY OF THE INVENTION

The method according to the invention has the advantage that a delay in the build up of torque, which delay follows in the case of a variation of the performance of one of the exhaust gas turbochargers, is compensated for. Moreover, the method according to the invention achieves a situation where less expensive and less powerful exhaust gas turbochargers can be used, with unchanged performance of the drive device. It is provided according to the invention that the electric machine is actuated in a manner which is dependent on the time of the variation, in order to compensate for a deviation of an actual torque of the drive device from the setpoint torque. The electric machine is therefore actuated in a manner which is dependent on a performance change of one of the exhaust gas turbochargers, with the result that the electric machine is already actuated at an early stage in order to generate an assisting drive torque. By virtue of the fact that the actuation takes place in a manner which is dependent on the time of the variation, the impending loss of performance is counteracted at an early stage, with the result that it does not have an effect which reduces the driving comfort, in particular. By way of the actuation of the electric machine, the time until the desired boost pressure is reached can therefore be bridged.

It is provided according to one preferred development of the invention that the performance of the second exhaust gas turbocharger is varied in such a way that the performance of the second exhaust gas turbocharger is increased if a first limit value is exceeded by the requested setpoint torque. If a torque is therefore requested from the drive device which exceeds a predefinable first limit value, the performance of the second exhaust gas turbocharger is increased, in order to increase the boost pressure which leads to a higher torque of the internal combustion engine. If the exhaust gas turbochargers are of different dimensions, it can also be provided that a change or switchover is made from the one exhaust gas turbocharger to the other exhaust gas turbocharger if the first limit value is exceeded.

It is preferably provided, however, that the performance of the second exhaust gas turbocharger is varied in such a way that the second exhaust gas turbocharger is not switched on until the first limit value is exceeded. If the first limit value is exceeded, the second exhaust gas turbocharger is therefore first of all deactivated and does not contribute to the boost pressure regulation. This can take place, for example, by virtue of the fact that the second exhaust gas turbocharger is assigned a bypass, in which an actuable valve, in particular a wastegate valve, lies. The exhaust gas flow is guided past the turbine of the exhaust gas turbocharger by way of the valve being opened, with the result that said turbine is not driven by the exhaust gas.

It is preferably provided, furthermore, that the first exhaust gas turbocharger also has means for varying its performance, the performance of the first exhaust gas turbocharger being varied in a manner which is dependent on the requested setpoint torque. As an alternative, it can be provided that the performance of the exhaust gas turbocharger can be influenced solely by the exhaust gas mass flow of the internal combustion engine, which exhaust gas mass flow is fed to its turbine. The first exhaust gas turbocharger is preferably likewise assigned a bypass with a switchable valve, through which bypass the exhaust gas mass flow of the internal combustion engine can be guided past the turbine of the first exhaust gas turbocharger. The throughflow cross section of the bypass can be changed by way of a variable setting of the valve, in order to influence the performance of the first exhaust gas turbocharger. The performance of the second exhaust gas turbocharger can also be varied correspondingly by way of the valve of the bypass which is added to it.

It is provided according to one preferred development of the invention that the current actual rotational speed or the current boost pressure of at least the second exhaust gas turbocharger is detected, and that the time of the variation is determined in a manner which is dependent on the detected actual rotational speed or a detected setpoint/actual deviation of the boost pressure. The detection of the current actual rotational speed or the setpoint/actual deviation or the actual boost pressure or the setpoint/actual deviation of the boost pressure determines in a simple way whether the performance of the second exhaust gas turbocharger is to be changed. In this way, the time, at which the performance of the second exhaust gas turbocharger is changed, can be determined in a simple way.

It is provided as an alternative or in addition that an actual actuating state of the means or the actuating variable of an actuator system for varying the performance of at least the second exhaust gas turbocharger is monitored, and the time for the activation of the electric machine or the time of the variation is determined in a manner which is dependent on the actual actuating state or the actuator position/actuating variable. To this end, for example, the actual actuating state or the actuator position of the valve of the bypass which is assigned to the second exhaust gas turbocharger is monitored. It can be provided, in particular, that a duty factor of the actuation or of an actuator of the valve is monitored to this end. The performance of the second exhaust gas turbocharger is changed in a manner which is dependent on the actual actuating state determined in this manner. Reliable determination of the time of the variation is therefore also ensured in this way.

It is preferably provided, furthermore, that the actuation of the electric machine is ended, in particular, in a manner which is dependent on a hysteresis when the actual rotational speed and/or the actual actuating state correspond/corresponds to a setpoint rotational speed and a setpoint actuating state, respectively. If the actual rotational speed corresponds to the setpoint rotational speed and/or the actual actuating state corresponds to the setpoint actuating state, it can be assumed that the second exhaust gas turbocharger has reached its desired performance. The assistance of the electric machine can therefore be ended. The advantageous hysteresis takes into consideration that the boost pressure rises in a delayed manner with respect to the performance increase of the exhaust gas turbocharger on account of the dynamic flow conditions in the air system of the internal combustion engine. The hysteresis circuit therefore ensures that the assistance by way of the electric machine is not ended prematurely.

It is provided according to a further preferred embodiment of the invention that the electric machine is advantageously actuated in a manner which is dependent on a requested gear change. As a result, in particular, a brief traction interruption during a shifting operation can be compensated for. In this way, the torque which is provided overall by the drive device can also be maintained during a shifting operation, as a result of which, inter alia, the change to the next transmission ratio is also improved and downshifts are avoided. In the case of a requested gear change for the downshift, in particular, a check is carried out as to whether said downshift can be avoided by way of an actuation of the electric machine. Accordingly, when the torque increase of the drive device which is to be achieved by way of the downshift can be compensated for by way of an increased drive torque of the electric machine, the downshift is prevented and the electric machine is actuated correspondingly instead. In the case of an upshift, the required additional performance or the required torque of the electric machine is preferably determined, in order to compensate for the delayed build up of boost pressure in an optimum manner, as has already been described above.

The device for operating a drive device of a motor vehicle, according to the invention, is distinguished by a specially designed control unit which carries out the method according to the invention in the case of use as intended. The advantages which have already been mentioned arise as a result.

The drive device according to the invention is distinguished by the device according to the invention. The advantages which have already been mentioned arise as a result.

In the following text, the invention and its advantages are to be described in greater detail using the drawing, in which:

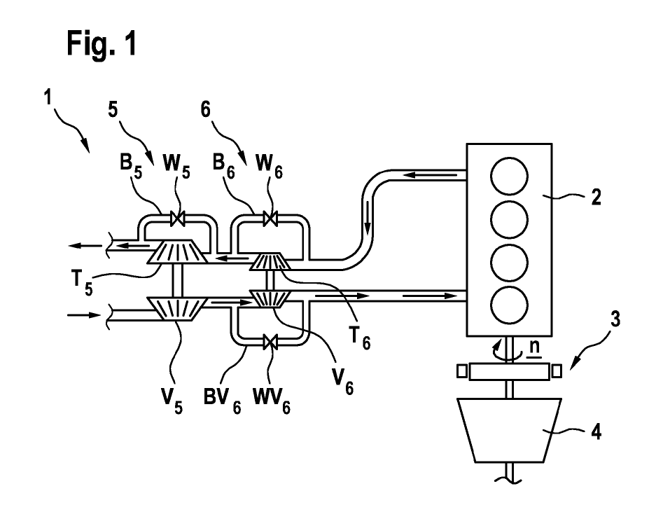

FIG. 1 shows a drive device of a motor vehicle in a simplified illustration,

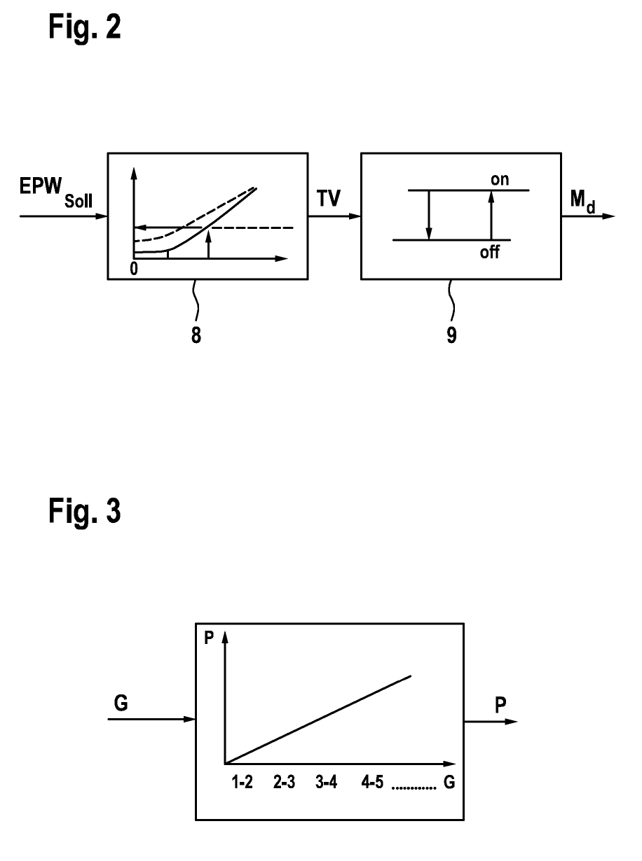

FIG. 2 shows a method for operating the drive device, and

FIG. 3 shows a further method for operating the drive device.

### DETAILED DESCRIPTION

FIG. 1 shows a simplified illustration of a drive device 1 of a motor vehicle (not shown in greater detail here). The drive device 1 has an internal combustion engine 2 which is configured as a reciprocating piston engine. The internal combustion engine 2 or a crankshaft of the internal combustion engine 2 is connected to an electric machine 3. In particular, a rotor of the electric machine 3 is directly arranged fixedly on the crankshaft 2 or the output shaft of the internal combustion engine 2 so as to rotate with it. The electric machine 3 is in turn connected to a transmission 4 which connects the drive device 1 to drive wheels of the motor vehicle. Here, in particular, the transmission 4 has a plurality of transmission stages, between which shifting can be carried out.

The internal combustion engine 2 is assigned two exhaust gas turbochargers 5 and 6 which are connected in series to one another. The two exhaust gas turbochargers 5, 6 have in each case one turbine T₅, T₆ and a compressor V₅ and V₆ which is connected to the turbine. The exhaust gas turbochargers 5 and 6 are connected in series to one another, with the result that exhaust gas which comes from the internal combustion engine 2 is first of all fed to the turbine T₆ of the exhaust gas turbocharger 6 and subsequently to the turbine T₅ of the exhaust gas turbocharger 5. Accordingly, fresh air is first of all fed to the compressor V₅ of the exhaust gas turbocharger 5 and subsequently to the compressor V₆ of the exhaust gas turbocharger 6, with the result that the fresh air is compressed by way of the compressor V₅ and subsequently the compressor V₆ and is only then fed to the internal combustion engine 2.

The turbines T₅ and T₆ are in each case assigned a bypass B₅ and B₆, respectively, which in each case have a switchable wastegate valve W₅ and W₆, respectively, by way of which a throughflow cross section of the respective bypass B₅, B₆ can be set. If the respective bypass B₅, B₆ is closed completely by way of the respective wastegate valve W₅, W₆, the exhaust gas or the exhaust gas mass flow of the internal combustion engine 2 is guided completely through the turbines T₆ and T₅, in order to drive the two exhaust gas turbochargers T₅ and T₆.

In the present case, the compressor V₆ is also assigned a further bypass BV₆ with a further valve WV₆, by way of which the fresh air flow which is fed to the compressor V₆ can be regulated.

The wastegate valves W₅, W₆ and WV₆ are, in particular, means for varying the performance of the respective exhaust gas turbocharger 5, 6. By way of the actuation of the wastegate valves W₅ and W₆, for example, a switchover can be carried out during operation of the drive device 1 from two stage operation, in which the two exhaust gas turbochargers 5, 6 are operated, to one stage operation, in which only one of the exhaust gas turbochargers 5 or 6 is still operated. In the case of a switchover of this type, a delayed build up of boost pressure of the internal combustion engine 2 occurs on account of the dynamic flow conditions in the air guiding system. As a result, the actual torque of the drive device 1 follows a setpoint torque of the drive device 1 in a delayed manner, which setpoint torque is stipulated by a driver or is requested by a driver.

It is provided in the present case that, in the case of a switchover, the electric machine 3 is actuated to compensate for said deviation of the actual torque from the setpoint torque. To this end, it is provided in the present case that the electric machine is actuated in a manner which is dependent on the time of the variation of the performance of at least one of the exhaust gas turbochargers 5, 6, in order to generate an additional torque which compensates for the delayed build up of torque of the internal combustion engine 2. Here, in the present case, the example is assumed that a switchover is carried out between the exhaust gas turbochargers 5 and 6 if a predefinable limit value is exceeded by the requested setpoint torque, the high pressure stage, in particular, being decoupled in the case of a high performance request. For the switchover, the performance of the exhaust gas turbochargers 6 is varied by way of the actuation of the bypass. It is provided here that the wastegate valve W₆, and the other wastegate valves, are assigned an, in particular, electropneumatic actuator which moves or actuates the respective valve accordingly. The actuator is actuated, in particular, with a predefinable duty factor, a predefinable position of the respective valve resulting in a manner which is dependent on said duty factor.

The duty factor is monitored continuously by way of the control unit 7, in order to determine the performance of the exhaust gas turbocharger or a variation of the performance of the exhaust gas turbocharger 6 in a manner which is dependent on the actuating position of the actuator. In particular, the time, at which the performance of the exhaust gas turbocharger 6 is actually changed, can be determined by way of monitoring of the boost pressure deviation which results as a consequence of the performance of the exhaust gas turbocharger. In a manner which is dependent on said time, the electric machine 3 is actuated to compensate for that proportion of the torque increase which cannot be provided immediately by the internal combustion engine 2. As a result, the electric machine 3 is started up at an early stage such that a uniform torque increase and, in particular, no traction interruption are noticeable for the driver or occupants of a motor vehicle which has the drive device 1. The time of the switchover is advantageously fixed in such a way that the additional torque of the electric machine 3 acts in a manner which is controlled in advance, and a drop in the rotational speed is avoided as a result. This can be implemented, for example, by way of an actuating logic means of the control unit 7 in a manner which is dependent on the determined time of the variation or the boost pressure deviations and/or the actuating position of the actuator system, as has already been described above.

FIG. 2 shows a simplified illustration of a method for operating the drive device 1, in which method the time of the switchover is determined in a manner which is dependent on the duty factor. To this end, FIG. 2 shows a simplified flow diagram. First of all, in a step 8, the actuator of the wastegate valve 6 is actuated to set a setpoint duty factor (EPWₛₒₗₗ). In a manner which is dependent on the electric current, the characteristic curve which is inherent to the actuator results in a setpoint duty factor, from which an actual duty factor TV or an actual position of the wastegate valve 6 arises. As a result, the duty factor TV of the actuator is determined and, as a consequence of this, the time T, at which a variation of the performance of the exhaust gas turbocharger 6 takes place. The electric machine 3 is actuated in a manner which is dependent on said duty factor TV or time, a release hysteresis being used in the following step 9 to actuate the electric machine 3. Said hysteresis provides that the electric machine 3 is actuated (on) over a defined duty factor or time, at which the variation is detected, in order to compensate for the missing torque Md. The operation of the electric machine 3 is ended (off), however, in a delayed manner at the time, at which it can be assumed that the exhaust gas turbocharger 6 generates the desired performance.

For an improved connection of the torque during a shifting operation of the transmission 4, the compensation which is described in this regard by way of the electric machine 3 is likewise advantageous because the brief traction interruption of the transmission 4 during the shifting operation is bridged. As a result, the torque of the drive device 1 can also be kept at a higher level during the shifting operation, which improves the connection of the next transmission ratio and avoids downshifts. The advantage of an additional torque assistance by way of the electric machine 3 in a manner which is dependent on a gear change is the avoidance of the traction loss and the avoidance of a downshift, that is to say a higher gear can be utilized for a longer time by way of the electric additional drive.

In the case of a request for a gear change for a downshift, that is to say, for example, from third gear into second gear, a check is advantageously carried out as to whether said downshift can be avoided by way of the generation of an additional torque by way of the electric machine 3. Conversely, the required electric additional performance can be determined in the case of an upshift, in order to compensate for the delayed build up of boost pressure in an optimum manner.

To this end, for example, FIG. 3 shows the additional performance P which is to be provided by the electric machine 3 or the additional torque which is to be provided in a manner which is dependent on different gear changes G between the gears 1, 2, 3, 4 and 5 of the transmission 4.

1. A method for operating a drive device (1) of a motor vehicle, which drive device (1) has an internal combustion engine (2) with a first exhaust gas turbocharger (5) and a second exhaust gas turbocharger (6), and at least one electric machine (3), the first and second exhaust gas turbochargers (5, 6) being connected in series, at least the second exhaust gas turbocharger (6) having means for varying performance of the second exhaust gas turbocharger, and the method comprising varying the performance of at least the second exhaust gas turbocharger (6) in a manner which is dependent on a requested setpoint torque of the drive device (1), and actuating the electric machine (3) in a manner which is dependent on a time of the variation, in order to compensate for a deviation of an actual torque of the drive device (1) from the setpoint torque.

2. The method as claimed in claim 1, characterized in that the performance of the second exhaust gas turbocharger (6) is varied in such a way that the performance of the second exhaust gas turbocharger (6) is increased if a first limit value is exceeded by the requested setpoint torque.

3. The method as claimed in claim 1, characterized in that the performance of the second exhaust gas turbocharger (6) is varied in such a way that the second exhaust gas turbocharger (6) is not switched on until the first limit value is exceeded.

4. The method as claimed in claim 1, characterized in that the first exhaust gas charger (5) has means for varying performance of the first exhaust gas turbocharger, the performance of the first exhaust gas turbocharger (5) being varied in a manner which is dependent on the requested setpoint torque.

5. The method as claimed in claim 1, further comprising detecting a current actual rotational speed of at least the second exhaust gas turbocharger (6), and determining the time of the variation in a manner which is dependent on the detected actual rotational speed.

6. The method as claimed in claim 1, further comprising monitoring an actual actuating state of the means of at least the second exhaust gas turbocharger (6), and determining the time of the variation in a manner which is dependent on the actual actuating state.

7. The method as claimed in claim 1, characterized in that the actuation of the electric machine (3) is ended in a manner which is dependent on a hysteresis when the actual rotational speed and/or the actual actuating state correspond/corresponds to a setpoint rotational speed and a setpoint actuating state, respectively.

8. The method as claimed in claim 1, characterized in that the electric machine (3) is actuated in a manner which is dependent on a requested gear change.

9. A device for operating a drive device of a motor vehicle, wherein the drive device comprises a control unit configured to carry out the method as claimed in claim 1, and wherein the drive device has an internal combustion engine (2) with a first exhaust gas turbocharger (5) and a second exhaust gas turbocharger (6), and at least one electric machine (3), the first and second exhaust gas turbochargers (5, 6) being connected in series, and at least the second exhaust gas turbocharger (6) having means for varying performance of the second exhaust gas turbocharger.

10. A drive device (1) for a motor vehicle, the drive device comprising a device as claimed in claim 9, and the drive device having an internal combustion engine (2) which has a first exhaust gas turbocharger (5) and a second exhaust gas turbocharger (6), and having an electric machine (3), the first and second exhaust gas turbochargers (5, 6) being connected in series, and at least the second exhaust gas turbocharger (6) having means for varying performance of the second exhaust gas turbocharger.
